(19) United States
(12) Patent Application Publication
(10) Pub. No.: US 2013/0054028 A1
(43) Pub. Date: Feb. 28, 2013

(54) SYSTEM AND METHOD FOR CONTROLLING ROBOT

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/313,007

(22) Filed: Dec. 7, 2011

(30) Foreign Application Priority Data
Aug. 25, 2011 (TW) 100130443

(51) Int. Cl. B25J 9/16; B25J 19/04

(52) U.S. Cl. 700/259; 901/9; 901/47

(57) ABSTRACT

In a method for controlling a robot using a computing device, 3D images of an operator are captured in real-time. Different portions of the operator are determined in one of the 3D images according to moveable joints of the robot, and each of the determined portions is correlated with one of the moveable joints. Motion data of each of the determined portions is obtained from the 3D images. A control command is sent to the robot according to the motion data of each of the determined portions, to control each moveable joint of the robot to implement a motion of a determined portion that is correlated with the moveable joint.

### BACKGROUND

1. Technical Field

Embodiments of the present disclosure relate generally to robot control technologies and particularly to a system and method for controlling a robot using human motions.

2. Description of Related Art

Robots are widely employed for replacing humans or assisting humans in dangerous, dirty, or dull work such as in assembling and packing, transportation, earth exploration, and mass production of commercial and industrial goods. Additionally, the robots may execute tasks according to real-time human commands, preset software programs, or principles set with aid of artificial intelligent (AI) technologies. In a typical robot control method, a particular control device remotely controls most of the robots. However, the method needs operators to train in the use of the control device, which is inconvenient and time consuming.

### BRIEF DESCRIPTION OF THE DRAWINGS

FIG. 1 is a schematic diagram illustrating one embodiment of a computing device comprising a robot control system.

FIG. 2 is a block diagram of one embodiment of functional modules of the robot control system of FIG. 1.

FIG. 3 is a schematic diagram illustrating an example of a three dimensional (3D) image of a person captured by an image capturing device of FIG. 1.

FIG. 4 is a schematic diagram illustrating an example of determined portions of an operator corresponding to moveable joints of a robot of FIG. 1

FIG. 5 is a flowchart of one embodiment of a method for controlling the robot using the robot control system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

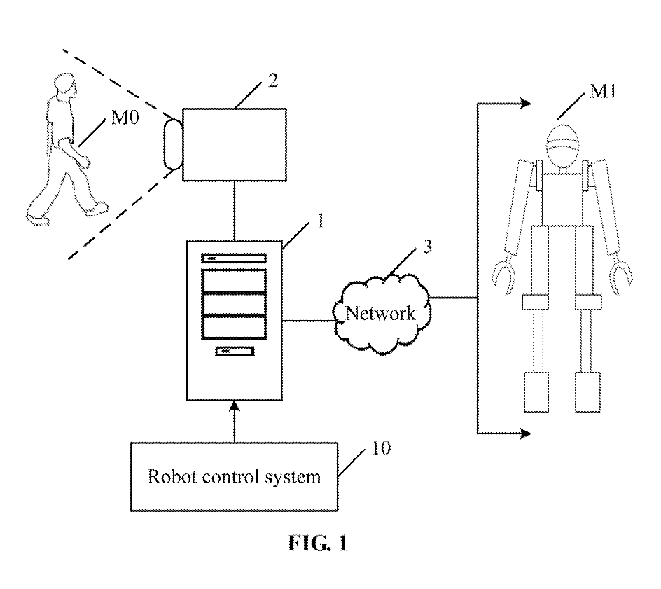

FIG. 1 is a schematic diagram illustrating one embodiment of a computing device 1 comprising a robot control system 1. In one embodiment, the computing device 1 electronically connects to an image capturing device 2, and communicates with a robot M1 through a network 3. The network 3 may be a wireless network or a cable network. The robot control system 10 captures real-time three dimensional (3D) images of an operator M0, analyzes the 3D images of the operator M0 to obtain motion data of the operator M0, and sends a control command to the robot M1 through the network 3, to control the robot M1 to execute the same motions with the operator M0 according to the motion data. The computing device 1 may be, for example, a server or a computer. It is understood that FIG. 1 is only one example of the computing device 1 that can include more or fewer components than those shown in the embodiment, or a different configuration of the various components.

In the embodiment, the robot M1 may operate in a vision field of the operator M0, so that the operator M0 can control the robot M1 using proper motions according to actual situations of the robot M1. In other embodiments, if the robot M1 is out of the vision field of the operator M0, the operator M1 may acquire real-time video of the robot M1 using an assistant device, such as a computer, to control the robot M0 according to the video.

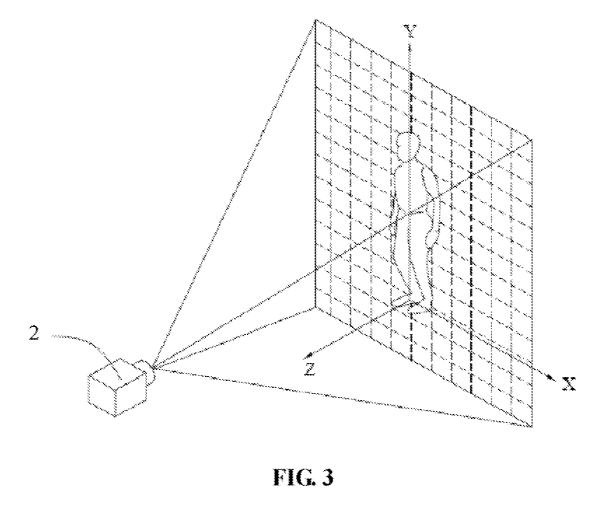

The image capturing device 2 may be a digital camera, such as a time of flight (TOF) camera, that is positioned in front of the operator M0 to capture 3D images of the operator M0. In one example, as shown in FIG. 3, the image capturing device 2 captures a 3D image of the operator M0. The 3D image can be described using a 3D coordinate system that includes X-Y coordinate image data, and Z-coordinate distance data. In one embodiment, the X-coordinate value represents a width of the image of the operator, such as 20 cm. The Y-coordinate value represents a height of the image of the operator, such as 160 cm. The Z-coordinate distance data represents a distance between the image capturing device 2 and the operator M0 that can be calculated by analyzing the 3D image.

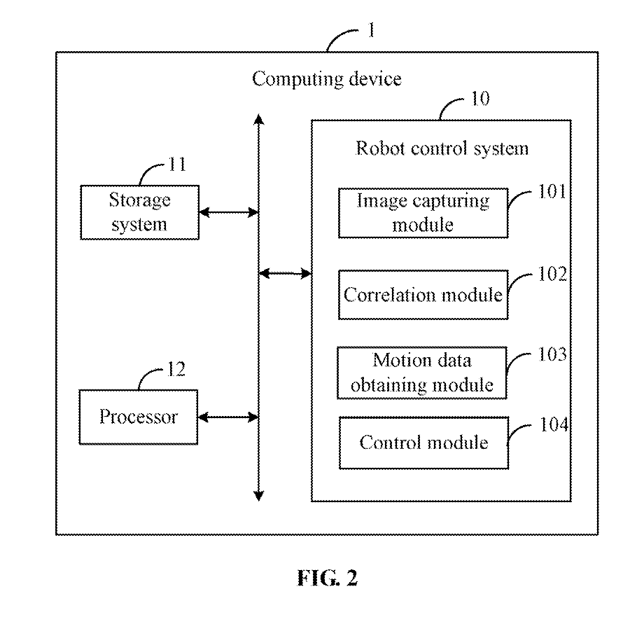

FIG. 2 is a block diagram of one embodiment of functional modules of the robot control system 10 of FIG. 1. In one embodiment, the robot control system 10 may include a plurality of software programs in the form of one or more computerized instructions stored in a storage system 11 and executed by a processor 12 of the computing device 1, to perform operations of the computing device 1. In the embodiment, the robot control system 10 includes an image capturing module 101, a correlation module 102, a motion data obtaining module 103, and a control module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The image capturing module 101 captures the 3D images of the operator M0 using the image capturing device 2 in real-time.

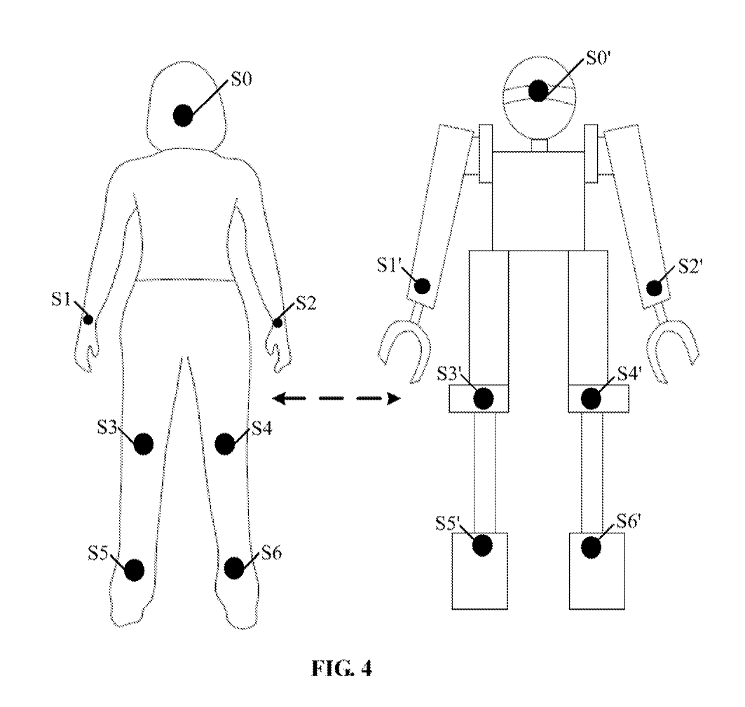

The correlation module 101 determines different portions of the operator M0 in one of the 3D images according to moveable joints of the robot M1, and correlates each of the determined portions with one of the moveable joints. In one example, as shown in FIG. 4, the operator M0 can be divided into portions S0, S1, S2, S3, S4, S5, and S6, and the robot M1 may have one or more moveable joints, such as S0′, S1′, S2′, S3′, S4′, S5′, and S6′, where S0 is correlated with S0′, S1 is correlated with S1′, . . . , and S6 is correlated with S6′.

The motion data obtaining module 103 obtains motion data of each of the determined portions of the operator M0 from the real-time 3D images of the operator M0. In the embodiment, the motion data may include a movement direction (X-Y-Z coordinates) of each of the determined portions of the operator M0, and a movement distance of each of the determined portions along the movement direction.

In one embodiment, the motion data obtaining module 103 may acquire a current 3D image and a previous 3D image of the operator M0 from the 3D images. In addition, the motion data obtaining module 103 may calculate the motion data of each of the determined portions by comparing position information (e.g., coordinate information) of each of the determined portions in the current 3D image and the previous 3D image. For example, the motion data obtaining module 103 may calculate a movement distance of the portion S1 along the Z-axis direction of FIG. 3 by comparing a Z-axis coordinate of the portion S1 in the current 3D image and the previous 3D image.

In other embodiment, the motion data obtaining module 103 may input the real-time 3D images of the operator M0 into a software program, which may be a middleware, such as an open natural interaction (OpenNI) software, to analyze the real-time 3D images using the middleware, and obtain the motion data of each of the determined portions from the middleware. The OpenNI software is middleware that can capture body movements and sounds of a user to allow for a more natural interaction of the user with computing devices in the context of a natural user interface.

The control module 104 generates a control command according to the motion data of each of the determined portions, and sends the control command to the robot M1 through the network 3, to control each moveable joint of the robot M1 to implement a motion of a determined portion of the operator M0 that is correlated with the moveable joint of the robot M1. In the embodiment, the control command includes the motion data of each of the determined portions of the operator M0. When the robot M1 receives the control command, the robot M1 may control the moveable joints to implement corresponding motions using its own driving system, such as a servomotor.

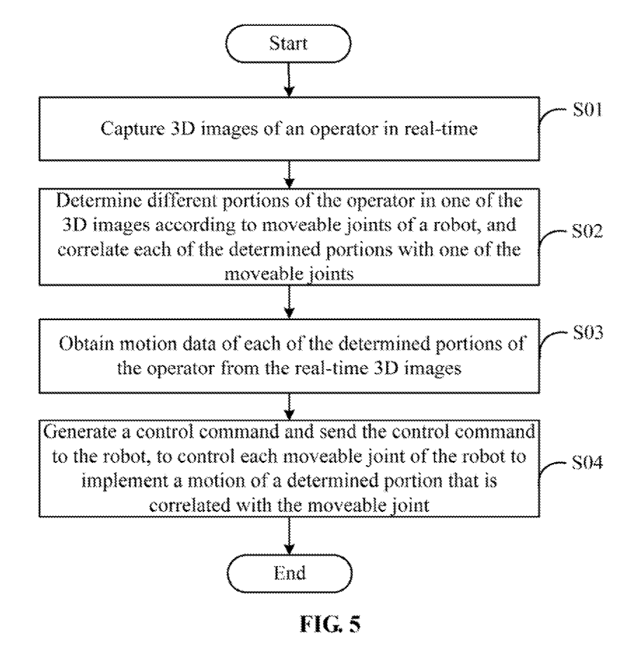

FIG. 5 is a flowchart of one embodiment of a method for controlling the robot using the robot control system 10 of FIG. 1. Depending on the embodiment, additional blocks may be added, others removed, and the ordering of the blocks may be changed.

In block S01, the image capturing module 101 captures the 3D images of the operator M0 in real-time using the image capturing device 2.

In block S02, the correlation module 101 determines different portions of the operator M0 in one of the 3D images according to the moveable joints of the robot M1, and correlates each of the determined portions with one of the moveable joints of the robot M1.

In block S03, the motion data obtaining module 103 obtains motion data of each of the determined portions of the operator M0 from the real-time 3D images of the operator M0. In the embodiment, the motion data may include a movement direction of each of the determined portions of the operator M0, and a movement distance of each of the determined portions along the movement direction. Details of obtaining the motion data are provided as the paragraph [0016] and paragraph [0017] as described above.

In block S04, the control module 104 generates a control command according to the motion data of each of the determined portions, and sends the control command to the robot M1 through the network 3, to control each moveable joint of the robot M1 to implement a motion of a determined portion that is correlated with the moveable joint. In the embodiment, the control command includes the motion data of each of the determined portions of the operator M0. When the robot M1 receives the control command, the robot M1 may control the moveable joints to implement corresponding motions using its own driving system.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for controlling a robot using a computing device, the robot comprising a plurality of moveable joints, the method comprising:
capturing 3D images of an operator in real-time using an image capturing device that is electronically connected to the computing device;
determining different portions of the operator in one of the 3D images according to the moveable joints of the robot, and correlating each of the determined portions with one of the moveable joints;
obtaining motion data of each of the determined portions from the real-time 3D images;
generating a control command according to the motion data of each of the determined portions, and sending the control command to the robot; and
controlling each movement joint of the robot to implement a motion of a determined portion of the operator that is correlated with the movement joint according to the control command.

2. The method according to claim 1, wherein the motion data is obtained by:
acquiring a current 3D image and a previous 3D image of the operator from the captured 3D images; and
calculating the motion data of each of the determined portions by comparing position information of each of the determined portions in the current 3D image and the previous 3D image.

3. The method according to claim 1, wherein the motion data is obtained by:
inputting the real-time 3D images of the operator into a software program to analyze the real-time 3D images using the software program; and
obtaining the motion data of each of the determined portions from the software program.

4. The method according to claim 1, wherein the motion data comprise a movement direction of each of the determined portions of the operator, and a movement distance of each of the determined portions along the movement direction.

5. The method according to claim 1, wherein the control command comprises the motion data of each of the determined portions of the operator, and the moveable joints of the robot are controlled using a driving system of the robot.

6. A computing device that communicates with a robot that comprises a plurality of moveable joints, the computing device comprising:
a storage system;
at least one processor;
one or more programs stored in the storage system and executed by the at least one processor, the one or more programs comprising:
an image capturing module operable to capture 3D images of an operator in real-time using an image capturing device that is electronically connected to the computing device;
a correlation module operable to determine different portions of the operator in one of the 3D images according to the moveable joints of the robot, and correlate each of the determined portions with one of the moveable joints;
an motion data obtaining module operable to obtain motion data of each of the determined portions from the real-time 3D images; and
a control module operable to generate a control command according to the motion data of each of the determined portions, and send the control command to the robot, to control each movement joint of the robot to implement a motion of a determined portion of the operator that is correlated with the movement joint.

7. The computing device according to claim 6, wherein the motion data is obtained by:
acquiring a current 3D image and a previous 3D image of the operator from the 3D images; and
calculating the motion data of each of the determined portions by comparing position information of each of the determined portions in the current 3D image and the previous 3D image.

8. The computing device according to claim 6, wherein the motion data is obtained by:
inputting the real-time 3D images of the operator into a software program to analyze the real-time 3D images using the software program; and
obtaining the motion data of each of the determined portions from the software program.

9. The computing device according to claim 6, wherein the motion data comprise a movement direction of each of the determined portions of the operator, and a movement distance of each of the determined portions along the movement direction.

10. The computing device according to claim 6, wherein the control command comprises the motion data of each of the determined portions of the operator, and the moveable joints of the robot are controlled using a driving system of the robot.

11. A non-transitory storage medium storing a set of instructions, the set of instructions capable of being executed by a processor of a computing device, causes the computing device to perform a method for controlling a robot that comprises a plurality of moveable joints, the method comprising:
capturing 3D images of an operator in real-time using an image capturing device that is electronically connected to the computing device;
determining different portions of the operator in one of the 3D images according to the moveable joints of the robot, and correlating each of the determined portions with one of the moveable joints;
obtaining motion data of each of the determined portions according to the real-time 3D images;
generating a control command according to the motion data of each of the determined portions, and sending the control command to the robot; and
controlling each movement joint of the robot to implement a motion of a determined portion of the operator that is correlated with the movement joint according to the control command.

12. The non-transitory storage medium according to claim 11, wherein the motion data is obtained by:
acquiring a current 3D image and a previous 3D image of the operator from the 3D images; and
calculating the motion data of each of the determined portions by comparing position information of each of the determined portions in the current 3D image and the previous 3D image.

13. The non-transitory storage medium according to claim 11, wherein the motion data is obtained by:
inputting the real-time 3D images of the operator into a software program to analyze the real-time 3D images using the software program; and
obtaining the motion data of each of the determined portions from the software program.

14. The non-transitory storage medium according to claim 11, wherein the motion data comprise a movement direction of each of the determined portions of the operator, and a movement distance of each of the determined portions along the movement direction.

15. The non-transitory storage medium according to claim 11, wherein the control command comprises the motion data of each of the determined portions of the operator, and the moveable joints of the robot are controlled using a driving system of the robot.
